(19) United States
(12) Patent Application Publication
(10) Pub. No.: US 2024/0351239 A1
(43) Pub. Date: Oct. 24, 2024

(54) DEVICE FOR SAWING AND SPLITTING WOOD

(71) Applicant: POSCH Gesellschaft m.b.H., Leibnitz (AT)

(72) Inventor: Markus Handl, Schwarzautal (AT)

(21) Appl. No.: 18/640,254

(22) Filed: Apr. 19, 2024

(30) Foreign Application Priority Data
Apr. 19, 2023 (AT) A50289/2023

(51) Int. Cl. B27L 7/06; B27B 5/00; B27B 31/00

(52) U.S. Cl. CPC B27L 7/06; B27B 5/00; B27B 31/006

(57) ABSTRACT

A machine for cutting and splitting logs includes a saw for cutting off a piece of wood from a log, a first receiver for a log that is to be cut, and a splitter for splitting a piece of wood into pieces, a splitting channel with a second receiver for the piece of wood that is to be split, wherein the splitting channel with the second receiver is downstream of the first receiver, and wherein the splitting channel may be tilted at an angle greater than 0° to horizontal when the machine is ready for use.

### CROSS REFERENCES

This application claims priority to Austrian Application No. A50289/2023, filed Apr. 19, 2023, the entire disclosure of which is hereby incorporated by reference herein.

### TECHNICAL FIELD

The present disclosure relates to a machine for cutting and splitting logs.

### BACKGROUND

Machines for both cutting and splitting logs are disclosed in the prior art with which a piece of wood can be cut from a log with a sawblade or chainsaw, and subsequently split by a splitter in the same machine. In the simplest case, the piece of wood falls into the splitter due to gravity, or it is moved there by a wood manipulating unit. After falling into a splitting channel in the splitter, the piece of wood is pushed against a splitting wedge by a ram, thus splitting it.

One problem with gravity moving the pieces of wood from the saw to the splitter is caused by irregularities in the shape of wood, e.g., when they are not perfectly round, are extremely knotty, or are very short but have a large circumference. These pieces of wood can get misaligned in the splitting channel and must be realigned manually. Opening the safety mechanisms to correct the placement of the wood in the splitting channel interrupts the workflow and slows progress.

A machine for cutting and splitting logs is disclosed in DE 20010048 U1 with a stop for the piece of wood that has been cut off, which guides the piece of wood into the splitting channel as long as the ram is in the splitting chamber, preventing the piece of wood from being drawn back toward the sawblade. This protects the sawblade but does not prevent the piece of wood from falling sideways into the splitting channel. These manipulating elements also result in a more complicated machine, making it more difficult to repair and maintain.

### SUMMARY

An object of the present disclosure is therefore to create a machine for cutting and splitting logs with which the pieces of wood can be more reliably transferred from the saw to the splitter without increasing the technological complexity or requiring additional manipulating elements.

According to the present disclosure, the splitting channel may be tilted at an angle α that is greater than 0° to horizontal when the machine is ready for use.

This design results in a machine for cutting and splitting logs in which the center of gravity of the pieces of wood is shifted when falling into the splitting channel. In this manner, the weight of the piece of wood can be used to tip it toward and brace it against the ram, such that the piece of wood is more reliably positioned in the splitting chamber by the effects of gravity alone and is entirely prevented from falling sideways such that it would require manual corrective measures.

The “splitting channel” is understood in the context of the present disclosure to be that space in which the piece of wood that has been cut off is to be split by the components in the splitter responsible for splitting wood, and which is bordered by the second receiver below the machine when it is ready for use. “Ready for use” means when the machine can be used for its intended purpose in the context of the present disclosure.

Further advantageous embodiment variations of the machine according to the present disclosure for cutting and splitting logs are described in the dependent claims.

A particularly reliable means for preventing of pieces of wood from falling sideways into the splitting channel can be obtained when the splitting channel is tilted at an angle α that is greater than 0° and less than or equal to 45° to horizontal.

A particularly compact machine for cutting and splitting logs in which the log is particularly reliably prevented from falling sideways into the splitting channel is obtained when the splitting channel is tilted at an angle α of 5° to 15° to horizontal.

In one advantageous embodiment of the machine according to the present disclosure for cutting and splitting logs, the splitting channel can be tilted at an angle α of 10° to horizontal.

To be able to also reliably split a hardened and extremely knotty piece of wood with the machine according to the present disclosure, the splitter can contain a splitting tool, for example, a splitting wedge, that is at a right angle to the longitudinal axis of the second receiver and/or the splitting channel at the end further away from the saw.

To enable a safe and reliable splitting with the machine according to the present disclosure, the splitter can have a ram that pushes against the splitting tool, which moves back and forth, parallel to the longitudinal axis of the second receiver and/or the splitting channel in the splitter.

To ensure that a piece of wood that is to be split is reliably held in place in the second receiver, or on the supporting surface thereof, and is prevented from twisting, the second receiver in the splitter has a supporting surface on which the piece of wood can be placed that has a V-shaped cross section.

According to one advantageous embodiment of the machine according to the present disclosure for cutting and splitting logs, there can be a conveyor at the end of the second receiver further away from the saw for removing split pieces of wood, for example, a conveyor belt.

In particular in combination with a splitting channel that is tilted more than 0° in relation to the horizontal, with a splitting tool at a right angle to the second receiver, the transference to the conveyor for removing split wood, e.g., a conveyor belt, and operating reliability is substantially improved, because the angle between the splitter and the conveyor is reduced, and the height of the conveyor above the base is increased, such that the wood arrives on the conveyor with less potential interference.

According to an advantageous embodiment of the machine according to the present disclosure for cutting and splitting logs, for example, in combination with a conveyor, the splitting channel can be placed in the machine such that when ready for use, the end of the splitting channel further away from the saw is further away from the base than the end closer to the saw. The “base” is understood to be the surface on which the machine is placed when it is ready for use, e.g., a floor or some other suitable surface.

To reduce the width of the cuts and the amount of sawdust, the saw can contain a sawblade.

To ensure that the wood is reliably transferred from the saw to the splitter, the sawblade can be placed such that an imaginary extension thereof basically intersects the end surface of the ram in the middle when the ram in its starting position, which is as far away from the splitting tool in the splitter as possible. With this design, a piece of wood falling into the splitting channel is already turned toward the correct position prior to coming in contact with the splitting tool or the second receiver, ensuring that it is more reliably transferred into the splitting channel.

Further advantageous designs of the present disclosure can be derived from the description and the drawings.

These and other aspects are merely illustrative of the innumerable aspects associated with the present disclosure and should not be deemed as limiting in any manner. These and other aspects, features, and advantages of the present disclosure will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the present disclosure and wherein similar reference characters indicate the same parts throughout the views.

FIG. 1 shows a perspective view of an exemplary embodiment of a machine according to the present disclosure for cutting and splitting logs,

FIG. 2 shows a sectional view through the exemplary embodiment shown in FIG. 1,

FIG. 3 shows a detail of the sectional view shown in FIG. 2,

FIG. 4 shows another sectional view through the exemplary embodiment shown in FIG. 1,

FIG. 5 shows the sectional view from FIG. 4, with a schematically indicated piece of wood, or length of wood, and a sawblade.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. The following definitions and non-limiting guidelines must be considered in reviewing the description of the technology set forth herein.

In the following detailed description numerous specific details are set forth in order to provide a thorough understanding of the present disclosure. However, it will be understood by those skilled in the art that the present disclosure may be practiced without these specific details. For example, the present disclosure is not limited in scope to the particular type of industry application depicted in the figures. In other instances, well-known methods, procedures, and components have not been described in detail so as not to obscure the present disclosure.

The headings and sub-headings used herein are intended only for general organization of topics within the present disclosure and are not intended to limit the disclosure of the technology or any aspect thereof. In particular, subject matter disclosed in the “Background” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

The citation of references herein does not constitute an admission that those references are prior art or have any relevance to the patentability of the technology disclosed herein. All references cited in the “Detailed Description” section of this specification are hereby incorporated by reference in their entirety.

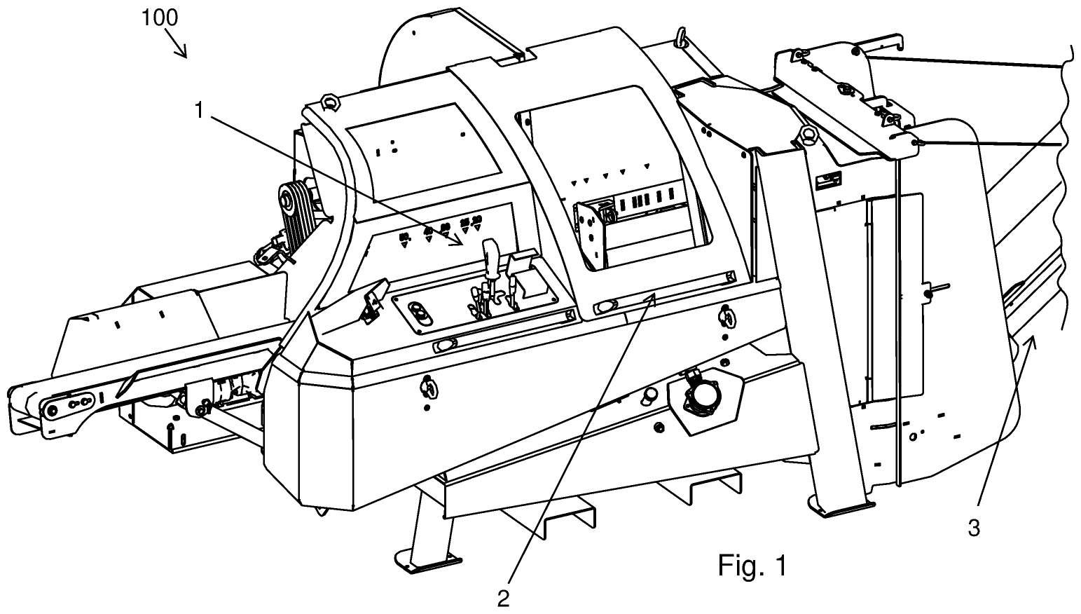

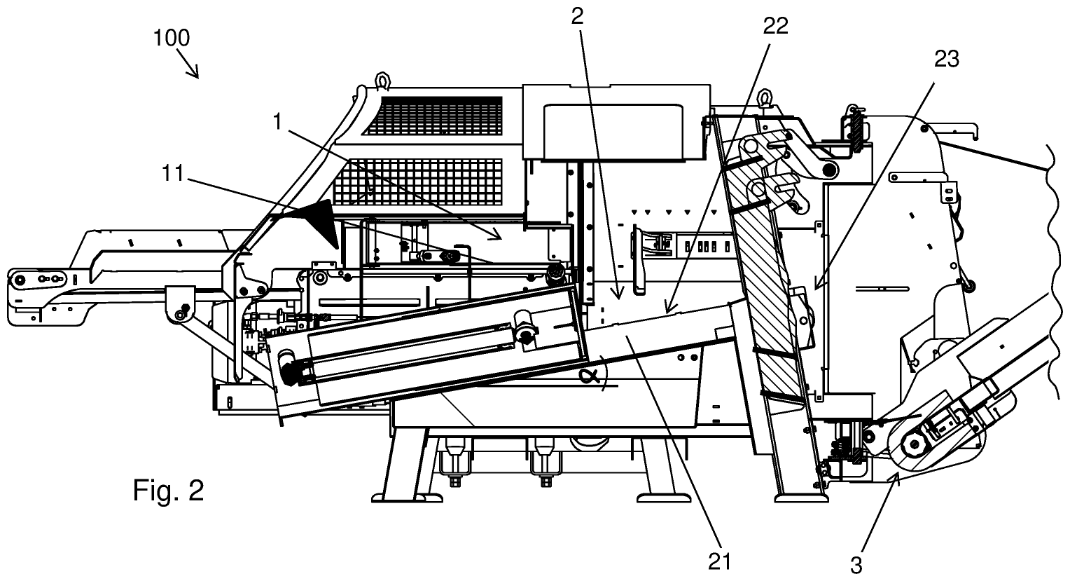

FIG. 1 shows an exemplary embodiment of a machine 100 according to the present disclosure for cutting and splitting logs from a diagonal perspective. The machine 100 contains a saw 1 and a splitter 2. In the illustration shown in FIG. 1 of the machine 100 according to the present disclosure, the saw 1 and splitter 2, as well as a conveyor, which shall be explained in greater detail below, are largely concealed by covers and protective elements, which provide safeguards for operators. FIG. 2 shows a sectional view through the machine 100 shown in FIG. 1.

The saw 1 contains a sawblade 12 in the exemplary embodiment, specifically a circular sawblade. Instead of a circular sawblade, the machine 100 according to the present disclosure can contain numerous circular sawblades, or at least one jigsaw blade, or bandsaw blade, or one or more saw chains.

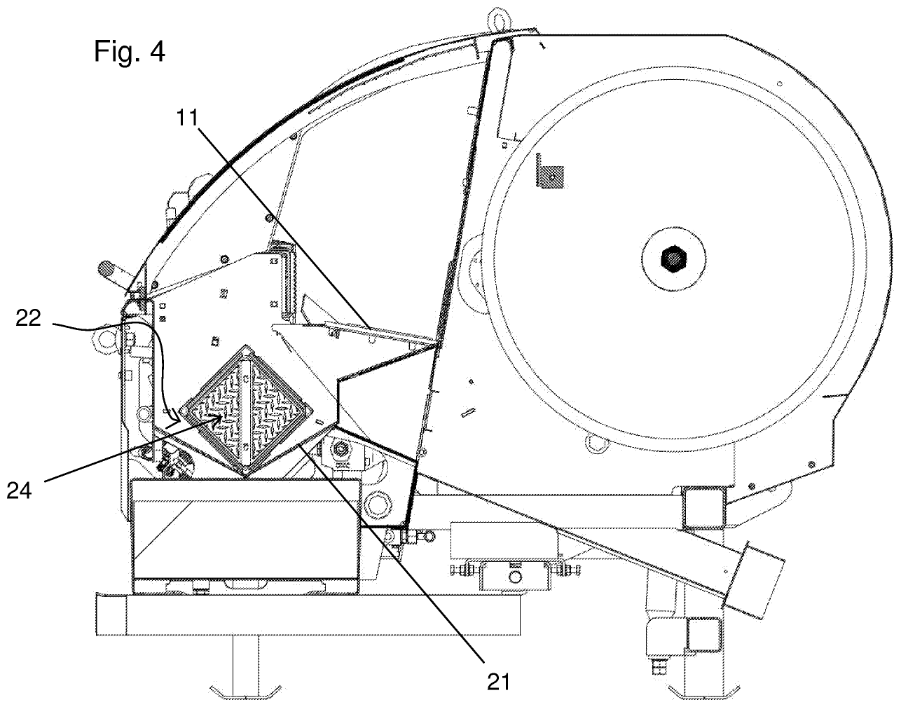

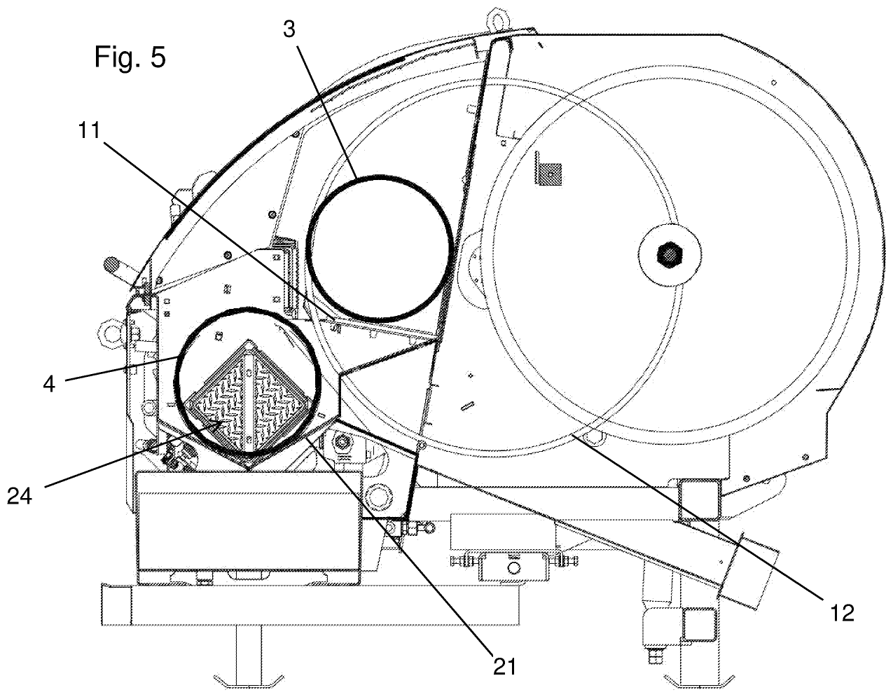

When the machine 100 is in operation, a piece of wood 4 is cut by the saw 1, or its sawblade 12, from a log 3 placed on the first receiver 11 (see FIG. 4 and FIG. 5). The first receiver 11 is a conveyor belt in this exemplary embodiment, on which the log 3 is placed, and automatically transported to the sawblade 12.

The piece of wood 4 then falls into the splitter 2, or the splitting channel 22, due to the effects of gravity (see FIG. 5). The splitter 2 has a splitting channel 22 in the form of a trough, comprising a second receiver 21 and a supporting surface with a V-shaped cross section (see FIG. 4 and FIG. 5). The piece of wood 4 falls onto the supporting surface in the second receiver 21 for the splitter 2. The piece of wood 4 is held in place by the V-shaped cross section.

There is a splitting tool in the form of a splitting wedge at the end of the splitting channel 22 facing away from the saw 1. The blade of the splitting wedge is at a right angle to the longitudinal axis of the splitting channel 22, or the longitudinal axis of the second supporting surface 21. The splitting wedge is star-shaped, with one long blade and two cross-blades, thus obtaining six pieces of split wood. The splitting wedge can also form a cross, with one long blade and one cross-blade, or it can have just a long blade, or more than two cross-blades.

The splitter 2 has a ram 24 that pushes the piece of wood against the splitting wedge. The ram 24 is at an end of the splitting channel 22 facing toward the saw 1 and can be moved back and forth in relation to the splitting wedge in the splitting channel 22, parallel to the longitudinal axis thereof, or the second supporting surface 21. In the exemplary embodiment, the ram 24 can only more toward and away from the splitting wedge in the splitting channel 22. When a piece of wood 4 is in the splitting channel 22, it is pushed against the splitting wedge and split into six pieces.

The saw 1 has an electric motor that drives the sawblade 12 directly. Alternatively, the sawblade can be powered by an electric motor with a V-belt, an internal combustion engine with a V-belt or a PTO with V-belts, in which case there may be a transmission between the sawblade drive and the sawblade 12. The splitter 2 also has an electric motor in the exemplary embodiment. Alternatively, the same motor can be used to power the saw 1 and the splitter 2, e.g., via a crankshaft.

If a particularly misshapen, or extremely knotty piece of wood, or a short piece of wood with a particularly large diameter, falls from the saw into the splitting channel, it may not be properly aligned in the splitting channel in conventional machines for cutting and splitting logs, i.e., such that instead of its longitudinal axis being parallel to the longitudinal axis of the splitting channel, it is transverse thereto. In this case, the operator must manually align the piece of wood in the splitting channel, requiring an interruption in the workflow and opening any safety elements.

To prevent the piece of wood from becoming misaligned in the splitting channel 22, the splitting channel 22 in the machine 100 according to the present disclosure for cutting and splitting logs is tilted at an angle greater than 0° (see FIG. 2). The splitting channel 22 is formed in the machine 100 such that the end thereof facing away, or further, from the saw 1 is higher than the end of the splitting channel facing, or closer to, the saw. This angle is the angle α formed between the horizontal and the splitting channel 22 when the machine 100 is ready for use.

In general, an angle α at which the splitting channel is tilted between 0° and 45° to horizontal is sufficient to prevent the piece of wood from becoming misaligned in the splitting channel 22. An angle of 5° to 15° has proven to be ideal, because the machine 100 can then be particularly compact, while still ensuring that the pieces of wood 4 will fall reliably into the splitting channel 22 with the correct alignment. Tests have shown that angle α of 10° is particularly ideal.

Test models have shown that a splitting channel tilted at this angle α is clearly more effective.

With pieces of wood with an average diameter of 33 cm, and a length of 20 cm, there is a 25-50% error rate with horizontal or level splitting channels in conventional machines for cutting and splitting logs.

With a splitting channel 22 tilted at an angle α of 10°, there was only a 0-1% error rate with the machine 100 according to the present disclosure for cutting and splitting logs.

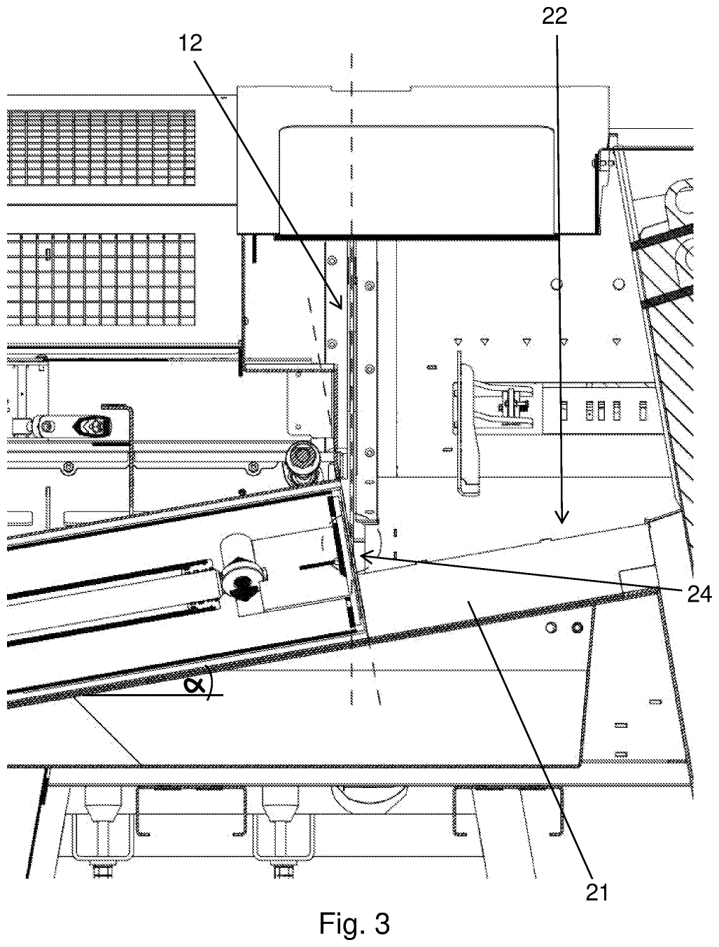

As shown in FIG. 3, the ram 24 and sawblade 12 are placed in the machine 100 shown in this exemplary embodiment such that an imaginary extension of the sawblade 12 basically intersects the end surface of ram 24 at the middle when the ram 24 is in the starting position. The starting position of the ram 24 is when it is as far away from the splitting tool in the splitter 2 as possible, i.e., the position from which the ram 24 starts to move toward the splitting tool, or splitting wedge.

This configuration increases the reliability with which the piece of wood is transferred from the saw 1 to the splitter 2, because this helps the piece of wood 4 that has been cut off to assume the desired alignment before it comes in contact with the splitter 2, or its second receiver 21.

As can be seen in FIG. 1 and FIG. 2, the machine 100 for cutting and splitting logs contains a conveyor 3 in the exemplary embodiment for removing the split pieces of wood, for example, a conveyor belt. Only part of the conveyor 3 is shown in FIG. 1 and FIG. 2. The conveyor 3 is located at the end 23 of the second receiver 21 facing away from the saw 1, i.e., at the end of the splitting channel 22, or second receiver 21, facing away from the saw 1. After a piece of wood 4 has been split by the splitter, the individual pieces of split wood fall directly onto the conveyor 3 with which they are removed.

By combining this conveyor 3 with a tilted splitting channel 22, the transfer and operating reliability to the conveyor 3 is substantially improved by the tilted splitting channel 22 with a splitting tool at a right angle to the longitudinal axis of the splitting channel 22 in comparison with conventional machines with level splitting channels. This is because the angle between the splitting direction and the conveyor 3 is smaller, and higher in relation to the base, such that the pieces of wood are transferred to the conveyor 3 with less interference.

This type of conveyor 3 is optional, and the machine 100 according to the present disclosure can also function without one. In this case, the split pieces of wood fall directly out of the splitter 2, or they are pushed out of the splitter 2 by subsequent pieces of split wood. These pieces of wood collect on the ground, or the surface on which the machine is placed, in the area at the end of the splitting channel 22 or second receiver 21 facing away from the saw 1 and can be picked up manually and moved from there to the desired location.

The preferred embodiments of the disclosure have been described above to explain the principles of the present disclosure and its practical application to thereby enable others skilled in the art to utilize the present disclosure. However, as various modifications could be made in the constructions and methods herein described and illustrated without departing from the scope of the present disclosure, it is intended that all matter contained in the foregoing description or shown in the accompanying drawings, including all materials expressly incorporated by reference herein, shall be interpreted as illustrative rather than limiting. Thus, the breadth and scope of the present disclosure should not be limited by the above-described exemplary embodiment but should be defined only in accordance with the following claims appended hereto and their equivalents.

What is claimed is:

1. A machine for cutting and splitting logs, comprising:
a saw for cutting off a piece of wood from a log, comprising a first receiver for the log;
a splitter for splitting a piece of wood into pieces, comprising a splitting channel with a second receiver for the piece of wood, wherein the splitting channel with the second receiver is downstream of the first receiver; and
wherein the splitting channel is tilted at an angle greater than 0° to horizontal when the machine is ready for use.

2. The machine according to claim 1, wherein the splitting channel is tilted at an angle of greater than 0° and less than or equal to 45° to horizontal.

3. The machine according to claim 1, wherein the splitting channel is tilted at an angle of 5° to 15° to horizontal.

4. The machine according to claim 1, wherein the splitting channel is tilted at an angle of 10° to horizontal.

5. The machine according to claim 1, wherein the splitter further comprises a splitting tool, wherein the splitting tool is at a right angle to at least one of a longitudinal axis of the second receiver and the splitting channel at the end of the splitting channel further away from the saw.

6. The machine according to claim 5, wherein the splitter comprises a ram configured to be pressed against the splitting tool, wherein the ram is further configured to be moved back and forth in the splitter, parallel to at least one of the longitudinal axis of the second receiver and the splitting channel.

7. The machine according to claim 5, wherein the second receiver in the splitter further comprises a support surface configured for the piece of wood to be placed on the support surface, and wherein the support surface comprises a V-shaped cross section.

8. The machine according to claim 1, further comprising a conveyor for removing split pieces of wood at a removal end of the second receiver facing away from the saw.

9. The machine according to claim 1, wherein the splitting channel is configured such that a first end of the splitting channel further away from the saw is further from a surface on which the machine rests than a second end of the splitting channel closer to the saw when the machine is ready for use.

10. The machine according to claim 1, wherein the saw comprises a cutting tool.

11. The machine according to claim 10, wherein the splitter further comprises a ram configured to be pressed against the splitting tool, wherein an imaginary extension of the cutting tool intersects an end surface of the ram when the ram is in a starting position adjacent a middle of the ram, and wherein the starting position of the ram is where the ram is furthest away from the splitting tool in the splitter.

12. The machine according to claim 5, wherein the splitting tool comprises a splitting wedge.

13. The machine according to claim 8, wherein the conveyor is a conveyor belt.
